(19) United States
(12) Patent Application Publication
(10) Pub. No.: US 2007/0141253 A1
(43) Pub. Date: Jun. 21, 2007

(54) Method of stopping leaks from rubber airbags of air spring/strut suspension systems using aerosol inflator systems in all motor vehicles

(76) Inventor: Peter Sinchun Chan, Monmouth Junction, NJ (US)

Correspondence Address: Wilson Daniel Swayze, Jr, 3804 Clearwater Ct., Plano, TX, 75025, US

(21) Appl. No.: 11/431,203

(22) Filed: May 10, 2006

Related U.S. Application Data
(60) Provisional application No. 60/759,292, filed on Jan. 17, 2006.
(60) Provisional application No. 60/751,933, filed on Dec. 21, 2005.

(51) Int. Cl. B05D 7/22

(52) U.S. Cl. 427/230; 427/140

(57) ABSTRACT

A method for repairing an air spring/air strut includes the steps of puncturing an airbag of the air spring/air strut, releasing sealant into the air bag of the air spring/air strut, massaging the air bag of the air spring/air strut to distribute the sealant and pressurizing the air bag of said air spring/air strut.

### PRIORITY

The present application claims priority under 35 USC section 119 and provisional application having a Ser. No. 60/759,292 filed on Jan. 17, 2006 and provisional application having a Ser. No. 60/751,933 filed on Jan. 12, 2006.

### FIELD OF THE INVENTION

The present invention relates to a method and apparatus for the reconditioning and repair of air spring/struts.

### BACKGROUND OF THE INVENTION

U.S. Pat. No. 3,385,590 discloses a closed or sealed vehicle suspension system including a telescopic strut, a reservoir and pump for controlling the gas flow between the strut, a reservoir and a pump motor. For some vehicle applications, it is desirable to incorporate an air spring into the suspension for improved ride, handling and load leveling capabilities. Air springs typically require large air volumes which are needed to produce an effective spring/strut including an airbag for storing the pressurized air.

These airbags may be inflated from a compressor from the vehicle or from a pump external to the vehicle such as a bicycle air pump.

U.S. Pat. No. 6,893,033 discloses a strut for a vehicle suspension system including a hydraulic cylinder housing defining a hydraulic fluid chamber.

These airbags are subject to wear and deterioration. Once these airbags develop a leak, the common practice has been to replace these airbags at great expense.

Air spring or air strut suspension systems are used in automobiles, SUVs, limousines, buses, and trucks in order to achieve a comfortable and smooth ride. However, the airbag will leak after approximately 6 to 8 years or 80,000 to 100,000 miles of use.

### SUMMARY OF THE INVENTION

The present invention includes a method and apparatus for repairing leaking rubber airbags used in conjunction with an air strut or air spring suspension system.

The present invention repairs and restores an airbag which is leaking by introducing a rubber or tire sealant into the rubber airbag through a needle or alternatively through the air supply line to the air strut or air spring.

The teachings of present invention are equally applicable to treat new and used air springs and struts of original equipment manufacturers (OEM) and replacement manufactures.

The present invention will prevent the necessity of converting an expensive air spring or air strut system to another new expensive air spring or air strut system.

The present invention is applicable to vehicles using independent air strut or air spring for each wheel or is applicable to a centrally computer-controlled compressor system.

This invention will revolutionize the air suspension repair industry and will result in the savings of hundreds of millions of dollars from the unnecessary or premature air strut or air spring replacement.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the dispensing unit of the present invention;

FIG. 2 illustrates a cross-sectional view of another embodiment of the dispensing of the present invention;

FIG. 3 illustrates a cross-sectional view of the dispensing unit and an airbag;

FIG. 4 illustrates a flow chart of the present invention.

### DETAILED DESCRIPTION

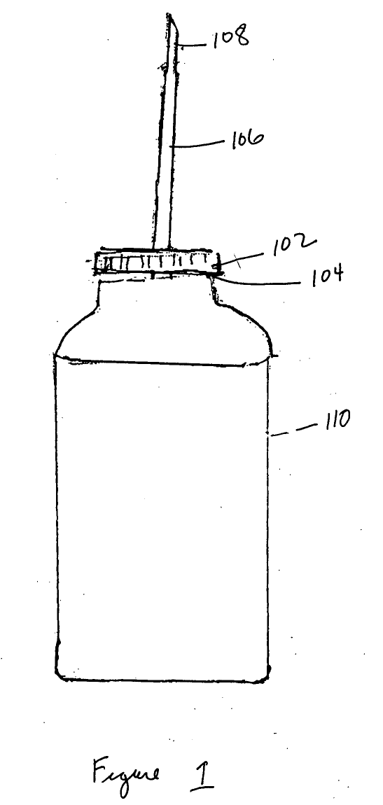

FIG. 1 illustrates the dispensing unit 100 which includes a hollow container 110 which may be flexible or a squeezable plastic bottle for containing sealant which may include tire sealant, air suspension sealant, or any other specially formulated rubber sealant. The container 110 includes a removable seal 104 which may be formed from aluminum, and the removable seal 104 is formed over the exit hole of the container 110 to retain and maintain the sealant before the dispensing unit 100 is to be used and is removed prior to the use of the dispensing unit 100. The container 110 includes a cap 102 to seal the exit hole of the container 110 and dispense the sealant. The cap 100 is connected to tube 106 to provide a path for the sealant to exit the container 100. The tube 106 may be flexible and may be formed from plastic so that the tube 106 can be slightly deformed to enter the airbag. A needle which may be formed from metal is connected to the distal end of tube 106 in order to puncture the airbag to allow the sealant to enter the airbag.

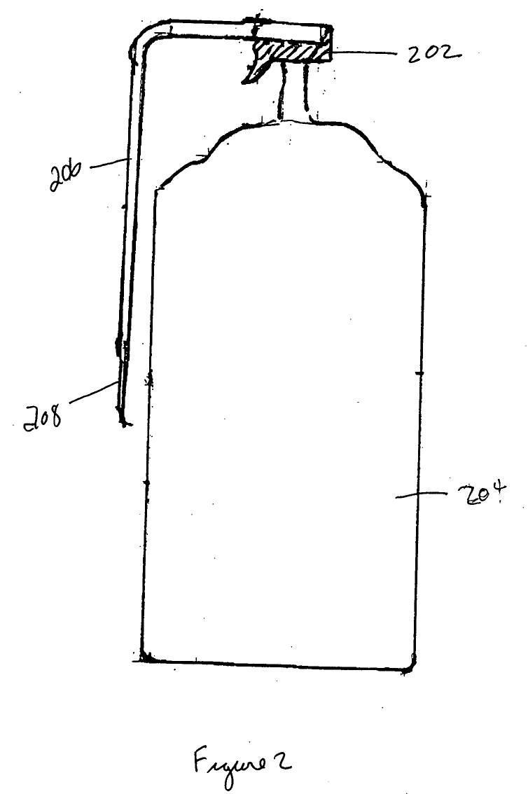

FIG. 2 illustrates a hollow container 204 which is pressurized with sealant, and the container 204 includes a valve 202 which may be opened and closed with the finger of the user. The container 204 includes hydro fluorocarbon HFC gas such as R-134a, compressed air, aerosol or other non-flammable, non-explosive gas to propel the sealant. The gas and sealant exit the container 204 through the tube 206 and needle 208.

The sealant may be a solution or semi suspension of acrylic resin polymers, vinyl polymers, or latex/rubber polymers or other type of tire sealant.

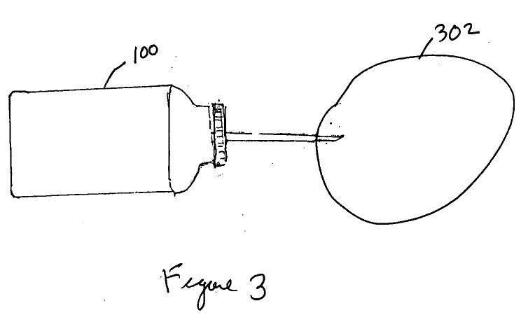

FIG. 3 illustrates the dispensing device 100 dispensing the sealant into the airbag 302.

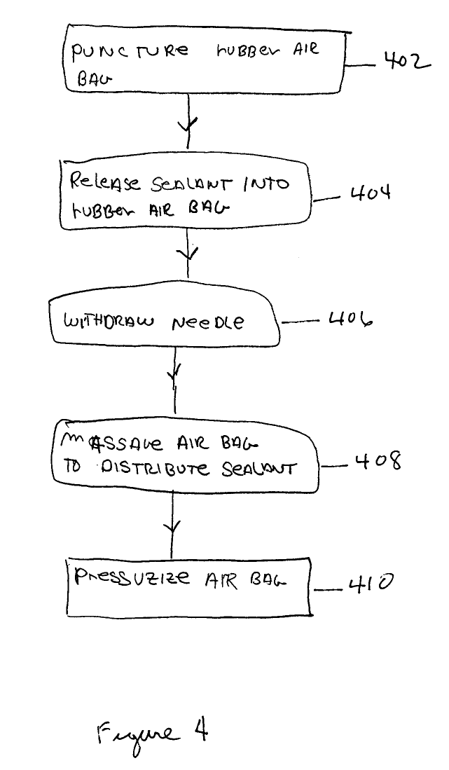

FIG. 4 illustrates a flow chart showing the steps of the invention. In step 402, the dispensing device 100 punctures the airbag 302 which may be in the lower regions of the airbag 302 since deterioration may be more prevalent in these regions. and in step 304 the sealant is released from the dispensing device 100 into the airbag 302. The sealant may be the released by squeezing the container 100 or released with pressurized gas through a valve. The user may squeeze 6 to 16 ounces or another quantity of sealant into the airbag 302. The sealant is now within the airbag 302 and the user withdraws the needle 108 from the airbag 302. In step 408, the user massages the airbag 302 or agitates the interior of the airbag 302 to distribute the sealant within the interior surface of the airbag 302. In step 410, the airbag 302 is pressurized either by the pump of the vehicle or by some other means such as a bicycle pump. The puncture hole caused by the needle 108 and the hole which was desired to be repaired are sealed by the sealant and the seal is permanent with the air strut or air spring now functioning normally.

The teachings of the present invention are extendable to air-adjustable shock absorbers in air compressor systems that operate with or without an air compressor.

The needle 108 may be formed from 16 to 18 gauge metal to provide a thin walled needle.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A method for repairing an air strut, comprising the steps of:
puncturing an airbag of said air strut;
releasing sealant into said air bag of said air strut;
massaging said air bag of said air strut to distribute said sealant;
pressurizing said air bag of said air strut.

2. A method for repairing an air strut as in claim 1, wherein said method includes the step of withdrawing a needle from said air bag of said air strut.

3. A method for repairing an air strut as in claim 1, wherein said step of puncturing includes the step of puncturing said air bag of said air strut with a needle.

4. A method for repairing an air strut as in claim 1, wherein said air bag is a new airbag.

5. A method for repairing an air strut as in claim 1, wherein said air bag is an old airbag.

6. A method for repairing an air strut as in claim 1, where in said step of releasing said sealant includes the step of releasing said sealant with a pressurized gas.

7. A method for repairing an air strut as in claim 1, wherein said step of releasing said sealant includes the step of releasing said sealant by squeezing a container.

8. A method for repairing an air strut as in claim 6, wherein said pressurized gas is hydro fluorocarbon.

9. A method for repairing an air strut as in claim 6, wherein said pressurized gas is compressed air.

10. A method for repairing an air strut as in claim 6, wherein said pressurized gas is aerosol.

11. A method for repairing an air spring, comprising the steps of:
puncturing an airbag of said air spring;
releasing sealant into said air bag of said air spring;
massaging said air bag of said air spring to distribute said sealant;
pressurizing said air bag of said air spring.

12. A method for repairing an air spring as in claim 11, wherein said method includes the step of withdrawing a needle from said air bag of said air spring.

13. A method for repairing an air spring as in claim 11, wherein said step of puncturing includes the step of puncturing said air bag of said air spring with a needle.

14. A method for repairing an air spring as in claim 11, wherein said air bag is a new airbag.

15. A method for repairing an air spring as in claim 11, wherein said air bag is an old airbag.

16. A method for repairing an air spring as in claim 11, where in said step of releasing said sealant includes the step of releasing said sealant with a pressurized gas.

17. A method for repairing an air spring as in claim 11, wherein said step of releasing said sealant includes the step of releasing said sealant by squeezing a container.

18. A method for repairing an air spring as in claim 16, wherein said pressurized gas is hydro fluorocarbon.

19. A method for repairing an air spring as in claim 16, wherein said pressurized gas is compressed air.

20. A method for repairing an air spring as in claim 16, wherein said pressurized gas is aerosol.
